(19) United States
(12) Patent Application Publication
(10) Pub. No.: US 2019/0122261 A1
(43) Pub. Date: Apr. 25, 2019

(54) COMMERCIAL SOFTWARE APPLICATION SYSTEM AND METHOD

(71) Applicant: Idit Sara Klimker-Rosen, Etobicoke (CA)

(72) Inventor: Idit Sara Klimker-Rosen, Etobicoke (CA)

(21) Appl. No.: 15/789,918

(22) Filed: Oct. 20, 2017

(51) Int. Cl. G06Q 30/02; G06F 17/30; G06N 5/02; G06Q 30/06

(52) U.S. Cl. CPC G06Q 30/0256; G06F 17/30867; G06F 17/3087; G06Q 30/0623; G06N 5/02; G06Q 30/0257; G06Q 30/0261

(57) ABSTRACT

A commercial software application system includes a platform server including a database, a registration software protocol configured to receive background information about a user and a supplier, a proximity software protocol configured to determine a location of the user and the supplier, an advertising software protocol configured to present the user with an advertisement, a transaction software protocol including a method for securely receiving and processing a commercial transaction, and a search engine communicably coupled to the platform server via a network. The registration software protocol, proximity software protocol, transaction software protocol, and advertising software protocol are configured to receive information from the search engine for creating a user profile. The system is useful for combining online search and shopping protocols with customized advertising from local retailers to enhance and streamline in-store shopping experiences.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of software applications of existing art and more specifically relates to a commercial software application system.

### RELATED ART

Today, when a customer wishes to buy a particular product offered by a particular brand, he/she may try to search for information related to that particular product, for example, using an online search engine, such as Google. Apart from information about features, reviews and/or prices of the particular product, the customer may be interested in knowing about brick-and-mortar retail stores from where he/she may purchase that particular product. In order to provide information that is more relevant to the customer, the online search engine typically organizes its search results with respect to a geographical location that could be of interest to the customer. The geographical location may, for example, be determined from at least one of: (a) an Internet Protocol (IP) address of a computing device from which the customer may have performed an online search, (b) a Global Positioning System (GPS) sensor of a smart phone from which the customer may have performed the online search, and/or (c) a name of a place provided by the customer in a search query itself.

Newer generation ‘millenials’ are currently using more mobile applications and online sources for their shopping needs. This trend has led to a significant decline both in sales and foot traffic for local brick-and-mortar retailers. As a result, many storefront locations in strip malls, shopping centers, and local establishments are being forced to search for alternative methods to reach and attract local consumers. A suitable solution is desired.

U.S. Pub. No. 2011/0246305 to Daniel M. Brazeau relates to an advertising website. The described advertising website includes a membership-based website that performs a comparative analysis of products and prices offered by retailers in a local community while permitting the user to shop online. The site provides this service at no cost to online shoppers. Moreover, the site provides critical and specific information to the user, such as where, when, how, and at what cost he or she may purchase the product “locally.” The membership base is made up of advertising agencies. The agencies pay a set fee, plus taxes, for twelve-month membership contracts. Under contract, the agencies are permitted to sell unlimited amounts of download space for a fixed and non-negotiable cost to as many retail store customers as desired.

### SUMMARY OF THE INVENTION

In view of the foregoing disadvantages inherent in the known software application art, the present disclosure provides a novel commercial software application system. The general purpose of the present disclosure, which will be described subsequently in greater detail, is to provide a software application that combines the convenience of online shopping routines with the physical presence and advertising of local retail establishments.

A commercial software application system is disclosed herein. The commercial software application system may include a platform server including a database, a registration software protocol configured to receive background information about a user and a supplier, a proximity software protocol configured to determine a location of the user and the supplier, an advertising software protocol configured to present the user with an advertisement, a transaction software protocol including a method for securely receiving and processing a commercial transaction, and a search engine communicably coupled to the platform server via a network. The registration software protocol, proximity software protocol, transaction software protocol, and advertising software protocol may be provided to receive information from the search engine for creating a user profile. The system may be useful for combining online search and shopping protocols with customized advertising from local retailers to enhance and streamline in-store shopping experiences.

According to another embodiment, a method for using a commercial software application system is also disclosed herein. The method for using a commercial software application system may include providing a commercial software application system, choosing a preferred language for the user, determining the location of the user, combining local search information with user background information, presenting customized advertising and search results for the user, and reserving a preferred product or service.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a commercial software application system, constructed and operative according to the teachings of the present disclosure.

FIG. 1 is a perspective view of the commercial software application system during an ‘in-use’ condition, according to an embodiment of the disclosure.

FIG. 2 is a flow diagram of the commercial software application system of FIG. 1, according to an embodiment of the present disclosure.

FIG. 3 is another flow diagram view of the commercial software application system of FIG. 1, according to an embodiment of the present disclosure.

FIG. 4 is a perspective view of the commercial software application system of FIG. 1 showing several software protocols of the system, according to an embodiment of the present disclosure.

FIG. 5 is a flow diagram illustrating a method for using a commercial software application system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to software applications and more particularly to a commercial software application system as used to improve the convenience of online shopping routines with the combined physical presence and advertising of local retail establishments.

Generally, the commercial software application system of this disclosure may include a software application that may provide online personal shopper services in 52 or more language for retail stores in a variety of geographical areas. The system may be referred to hereinafter as the “P.S. App”. The system and the included services may be offered for online retail stores as well as individual retail stores.

The commercial software application system may combine the online search behavior that many people enjoy with the touch and feel of a physical trip to a retail store. The system may offer online advertising with the added ability for allowing a user to reserve a product for private viewing in a retail store or shopping center. The system may also include customizable settings that allow the user to determine a suitable level of human interaction throughout the shopping experience. In addition, the system may provide valuable services to retail establishments by offering a plurality of advertising channels through which retailers may gain access to background information including geographic data, user preferences, shopping patterns, browsing histories, user measurements, and many other data points. Information such as this may be collected by the system and then sold to retailers for purposes of creating a client profile. These client profiles may be analyzed by artificial intelligence technologies integrated with the system and predictions may be made regarding future purchases.

With the commercial software application system, consumers may have to ask or opt-in to user agreements in order to see advertising offers and promotional materials. By asking to view included advertising, a user may be provided with on-demand online advertisements from all local retailers included in the system. In this manner, the system may act as a non-invasive sales person from a retail store. During the user experience, the system may collect information about the client or user which may help both retailers and consumers alike. Such information may include data about consumers' demands, current fashions, trends, preferred styles, preferences, pricing metrics and product availability. The system as a whole may be designed to help retailers develop long-term relationships with local consumer.

The system may be configured as a software application including a plurality of software protocols. The commercial software application system may include a platform server including a database, a registration software protocol configured to receive background information about a user and a supplier, a proximity software protocol configured to determine a location of the user and the supplier, an advertising software protocol configured to present the user with an advertisement, a transaction software protocol including a method for securely receiving and processing a commercial transaction, and a search engine communicably coupled to the platform server via a network. The registration software protocol, proximity software protocol, transaction software protocol, and advertising software protocol may be provided to receive information from the search engine for creating a user profile.

The commercial software application system may include two main sources of information: online advertisements from retail stores; and consumer searches. A consumer may download the software as a mobile application or use a web browser to access the system. A consumer may be able to choose a preferred language from a list of at least 52 languages that may suit their needs. The system may include search engine artificial intelligence (AI) that may direct users and clients to the software application based upon geographic location of the user. In addition, the Wi-Fi at a participating retail shopping center may be configured to navigate consumers to the commercial software application system when products are being searched using the retailer's Wi-Fi. Upon agreeing to terms and conditions of the software system, consumers may have access to advertising and promotions from participating retailers in the system. Such advertising may also include customized search responses and geographic notices based upon telemetry technology included in the system.

When using the commercial software application system, a consumer may be provided with search protocols that allow them to locate products, services, and brands from participating local inventories. If a user finds an item or service of interest, the user may then reserve that item through the software system for a predetermined time period. This time period may be configured as a 15-minute window that includes private, in store viewing privileges. After a product viewing has been completed, the user may have the option to purchase or decline the product. If a user decides not to reserve the product for viewing, the system may provide additional information or alternative products based upon user preferences that may be of interest to the consumer. Notifications from the system may be communicated to the user by means of email correspondence or in-app messages. After a successful transaction has been completed, the participating retailer may be a commission or referral fee to the P.S. App. Additional correspondence including follow-up notices may be sent after each shopping experience. Administrator buttons may be used for improving relationship with clients.

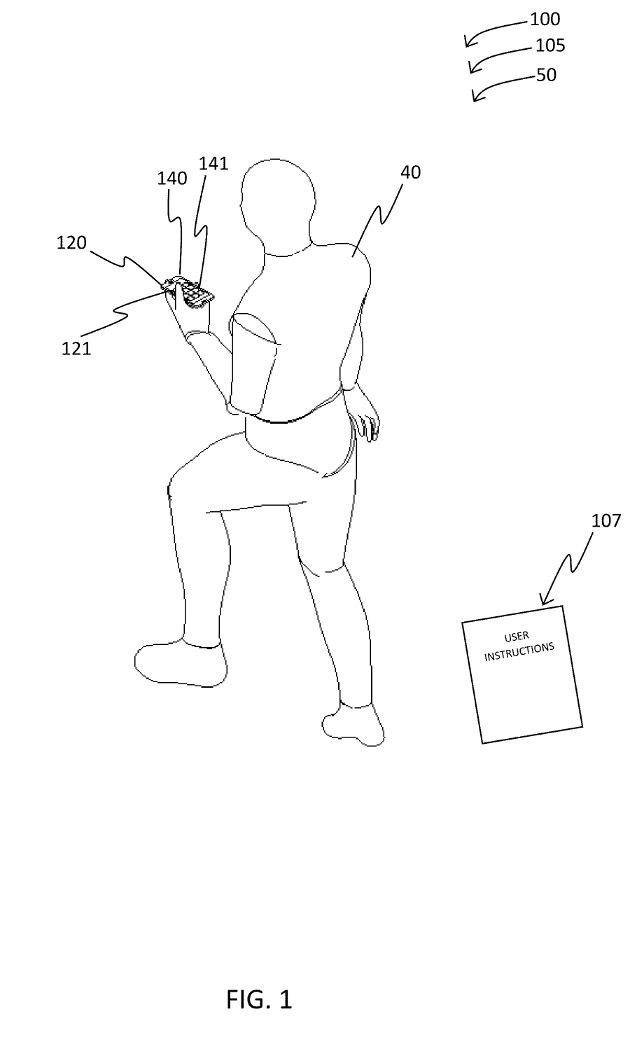

Referring now more specifically to the drawings by numerals of reference, there is shown in FIGS. 1-4, various views of a commercial software application system 100.

FIG. 1 shows a commercial software application system 100 during an ‘in-use’ condition 50, according to an embodiment of the present disclosure. Here, the commercial software application system 100 may be beneficial for use by a user 40 to improve the convenience of online shopping routines with the combined physical presence and advertising of local retail establishments. As illustrated, the commercial software application system 100 may include a registration software protocol 120 configured to receive background information 121 about a user 40. The commercial software application system 100 may be conveniently accessed on a mobile device and further include an advertising software protocol 140 configured to present the user with an advertisement 141.

According to one embodiment, the commercial software application system 100 may be arranged as a kit 105. In particular, the commercial software application system 100 may further include a set of instructions 107. The instructions 107 may detail functional relationships in relation to the structure of the commercial software application system 100 such that the commercial software application system 100 can be used, maintained, or the like, in a preferred manner.

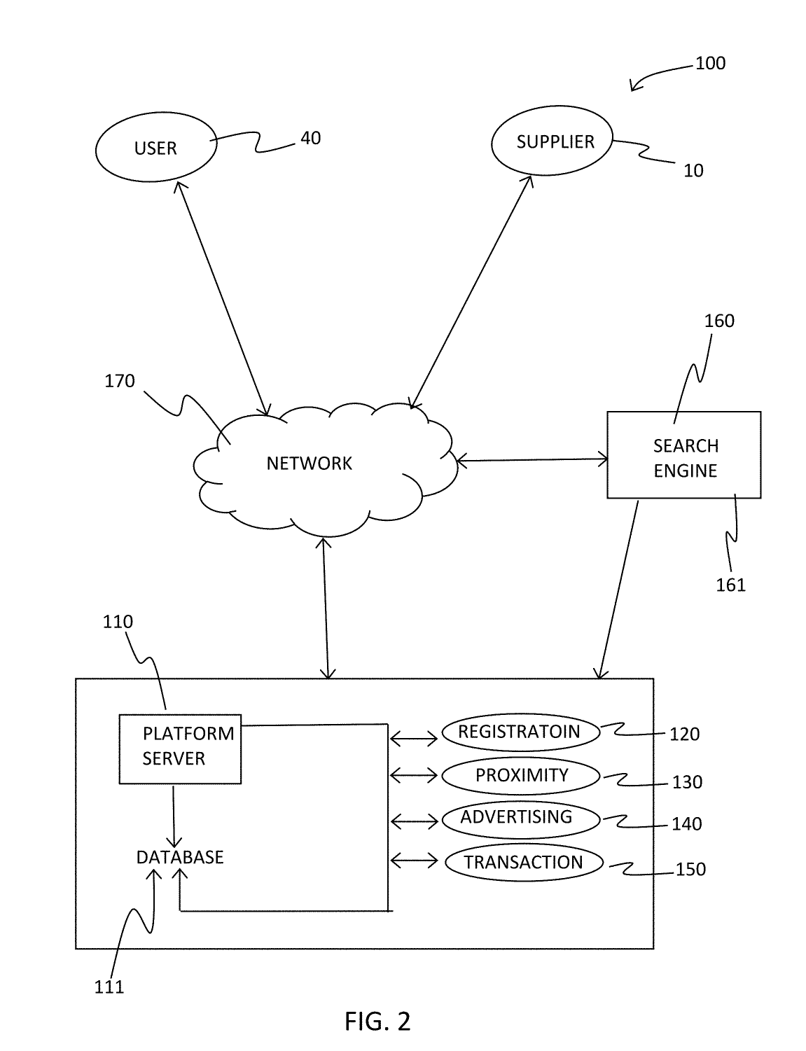

FIG. 2 shows the commercial software application system 100 of FIG. 1, according to an embodiment of the present disclosure. As above, the commercial software application system 100 may include a registration software protocol 120 configured to receive background information 121 (see FIG. 1) about a user 40 and a supplier 10. The commercial software application system 100 may operate from a platform server 110 including a database 111. The system 100 may be configured to interface with a search engine 160 communicably coupled to the platform server 110 via a network 170. The search engine 160 may further include an artificial intelligence feature 161 configured to compile and process data collected about the user 40. The commercial software application system 100 may also include a proximity software protocol 130 configured to determine a location of the user 40 and the supplier 10. In addition, the system 100 may feature an advertising software protocol 140 and a transaction software protocol 150 for completing commercial transactions.

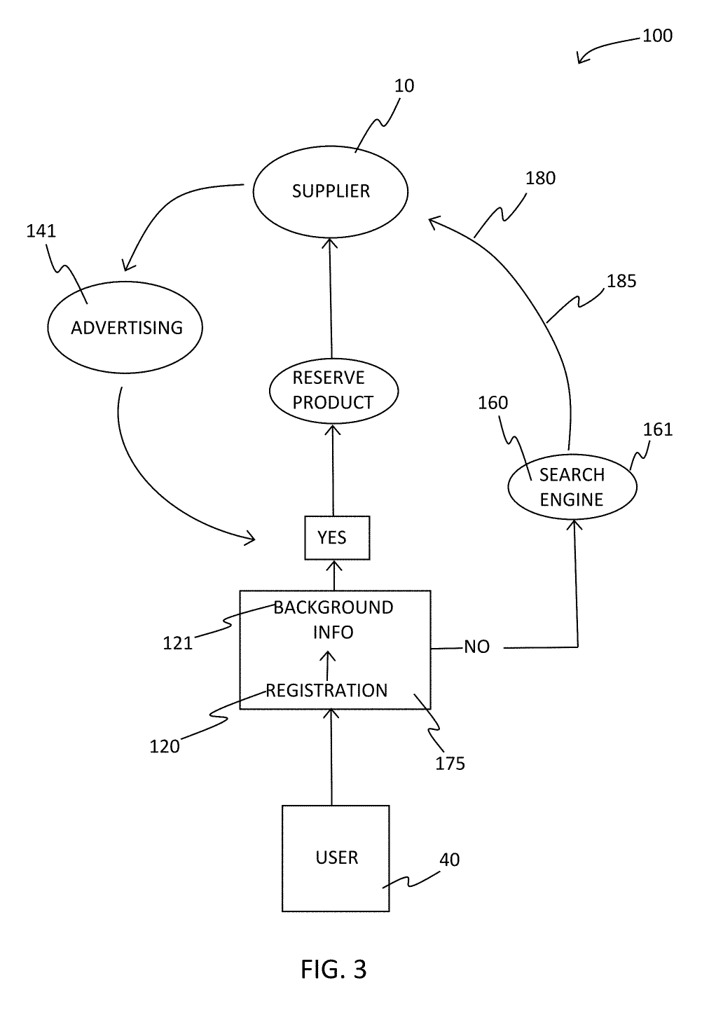

FIG. 3 is a flow diagram of the commercial software application system 100 of FIG. 1, according to an embodiment of the present disclosure. Here again, the commercial software application system 100 may be configured with a registration software protocol 120 configured to receive background information 121 and a set of user preferences 175 about a user 40 and a supplier 10. The commercial software application system 100 may be communicably coupled to a search engine 160 having an artificial intelligence feature 161 via a network 170 (see FIG. 2). The artificial intelligence feature 161 may be configured to analyze and adapt a user profile 180 through the collection of search criteria 185. This search criteria 185 may be used by a supplier 10 to present the user with an advertisement 141.

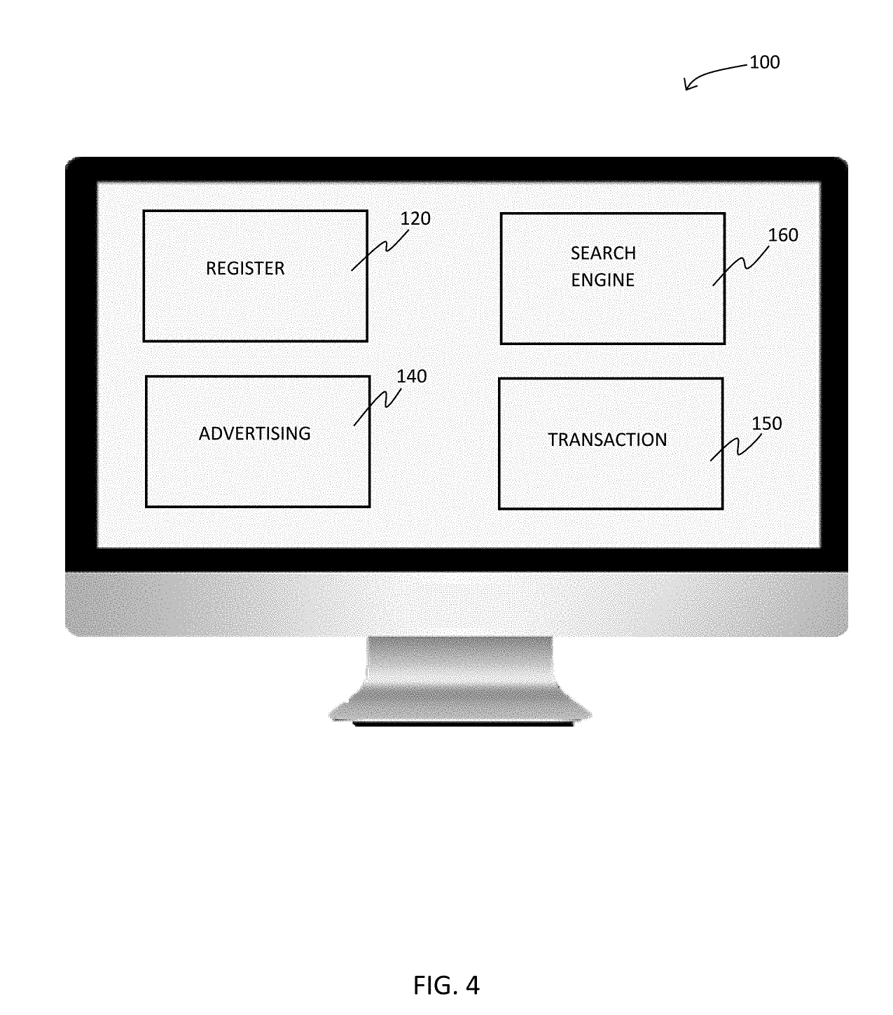

FIG. 4 is a perspective view of the commercial software application system 100 of FIG. 1, according to an embodiment of the present disclosure. As before, the commercial software application system 100 may include a registration software protocol 120, an advertising software protocol 140, and a search engine 160 communicably coupled to the platform server 110 (see FIG. 2) via a network 170 (see FIG. 2). The commercial software application system 100 may also include a transaction software protocol 150 configured to securely receive and process commercial transactions through the system 100.

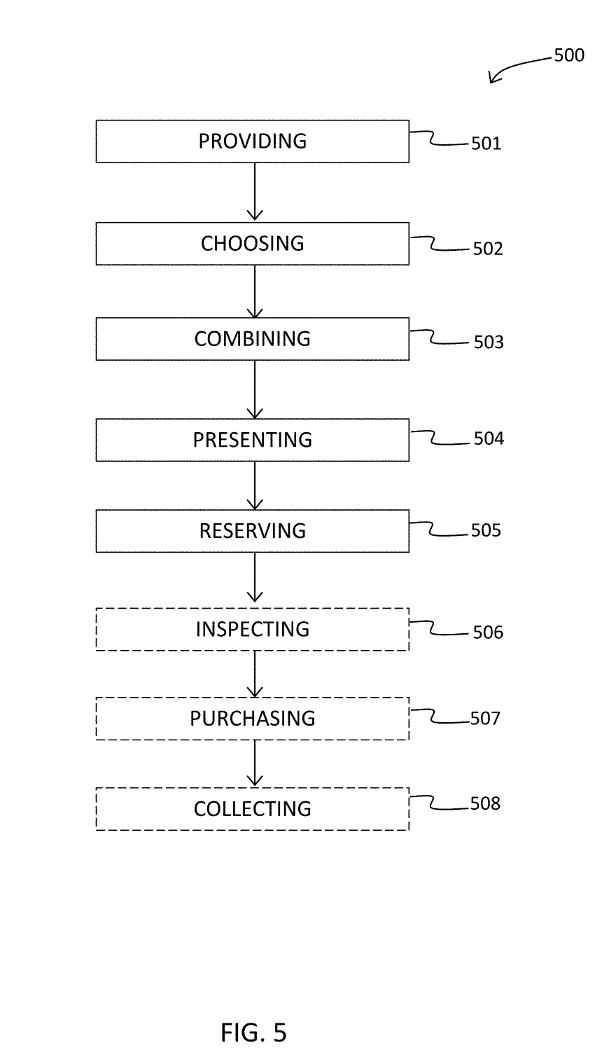

FIG. 5 is a flow diagram illustrating a method for using 500 a commercial software application system 100, according to an embodiment of the present disclosure. In particular, the method for using 500 a commercial software application system 100 may include one or more components or features of the commercial software application system 100 as described above. As illustrated, the method for using 500 a commercial software application system 100 may include the steps of: step one 501, providing a commercial software application system 100 including a platform server 110 having a database 111, a registration software protocol 120 configured to receive background information 121 about a user and a supplier 10, a proximity software protocol 130 configured to determine a location of the user and the supplier 10, an advertising software protocol 140 configured to present the user with an advertisement 141, a transaction software protocol 150 including a method for securely receiving and processing a commercial transaction 151, and a search engine 160 communicably coupled to the platform server 110 via a network 170; step two 502, choosing a preferred language for the user 40; step three 503, combining local search information with user 40 background information 121; step four 504, presenting customized advertising and search results for the user 40; and step five 505, reserving a preferred product or service.

It should be noted that step six 506, step seven 507 and step eight 508 are optional steps and may not be implemented in all cases. Optional steps of method for using 500 a commercial software application system 100 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for commercial software application system 100 are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A commercial software application system comprising:
a platform server including a database;
a registration software protocol configured to receive background information about a user and a supplier;
a proximity software protocol configured to determine a location of the user and the supplier;
an advertising software protocol configured to present the user with an advertisement;
a transaction software protocol including a method for securely receiving and processing a commercial transaction; and
a search engine communicably coupled to the platform server via a network; and
wherein the registration software protocol, proximity software protocol, transaction software protocol, and advertising software protocol are configured to receive information from the search engine for creating a user profile.

2. The commercial software application system of claim 1, wherein the supplier is a retail establishment existing within a specified distance from the user.

3. The commercial software application system of claim 2, wherein the specified distance is established through the proximity software protocol.

4. The commercial software application system of claim 1, wherein the registration software protocol is configured in at least 50 languages.

5. The commercial software application system of claim 1, wherein the background information collected via the registration software protocol is optional.

6. The commercial software application system of claim 1, wherein the background information is stored on the database.

7. The commercial software application system of claim 1, wherein the user profile is used to determine the advertisement presented to the user.

8. The commercial software application system of claim 1, wherein the transaction software protocol is further configured to physically reserve a product for the user at the supplier's location for a limited time.

9. The commercial software application system of claim 8, wherein the limited time is established by the system.

10. The commercial software application system of claim 1, wherein the search engine is configured to record background information about the user on the database.

11. The commercial software application system of claim 1, wherein the search engine comprises an artificial intelligence feature.

12. The commercial software application system of claim 1, further comprising a set of user preferences.

13. The commercial software application system of claim 12, wherein the set of user preferences includes at least one feature for customizing a level of preferred human interaction.

14. The commercial software application system of claim 1, wherein the user has to give permission for receiving the advertisement.

15. The commercial software application system of claim 1, wherein the user profile is adapted by a search criteria.

16. The commercial software application system of claim 15, wherein the search criteria includes a feature from a product features list including price, size, color, features, quantity, and availability.

17. A commercial software application system comprising:
a platform server including a database;
a registration software protocol configured to receive background information about a user and a supplier;
a proximity software protocol configured to determine a location of the user and the supplier;
an advertising software protocol configured to present the user with an advertisement;
a transaction software protocol including a method for securely receiving and processing a commercial transaction; and
a search engine communicably coupled to the platform server via a network;
further comprising a set of user preferences;
wherein the registration software protocol, proximity software protocol, transaction software protocol, and advertising software protocol are configured to receive information from the search engine for creating a user profile;
wherein the supplier is a retail establishment existing within a specified distance from the user;
wherein the specified distance is established through the proximity software protocol;
wherein the registration software protocol is available in at least 50 languages;
wherein the background information collected via the registration software protocol is optional;
wherein the background information is stored on the database;
wherein the user profile is used to determine the advertisement presented to the user;
wherein the transaction software protocol is further configured to physically reserve a product for the user at the supplier's location for a limited time;
wherein the limited time is established by the system;
wherein the search engine is configured to record background information about the user on the database;
wherein the search engine comprises an artificial intelligence feature;
wherein the set of user preferences includes at least one feature for customizing a level of preferred human interaction;
wherein the user has to give permission for receiving the advertisement;
wherein the user profile is adapted by a search criteria;
wherein the search criteria includes a feature from a product features list including price, size, color, features, quantity, and availability.

18. The commercial software application system of claim 17, further comprising set of instructions; and
wherein the system is arranged as a kit.

19. A method for using a commercial software application system, the method comprising the steps of:
providing a commercial software application system including a platform server having a database, a registration software protocol configured to receive background information about a user and a supplier, a proximity software protocol configured to determine a location of the user and the supplier, an advertising software protocol configured to present the user with an advertisement, a transaction software protocol including a method for securely receiving and processing a commercial transaction, and a search engine communicably coupled to the platform server via a network;
choosing a preferred language for the user;
determining the location of the user;
combining local search information with user background information;
presenting customized advertising and search results for the user; and
reserving a preferred product or service.

20. The method of claim 19, further comprising the steps of:
inspecting the preferred product or service;
purchasing the preferred product or service; and
collecting additional purchase data for enhancing local artificial intelligence used in product searches and advertisements.
